(19) United States
(12) Patent Application Publication
(10) Pub. No.: US 2001/0014149 A1
(43) Pub. Date: Aug. 16, 2001

(54) Communication system, communication apparatus, center apparatus, and download method

(76) Inventors: Yoshikatsu Ooi, Osaka (JP); Fumiaki Kobayashi, Yamatokoriyama-shi (JP); Takayuki Mizuno, Yamatokoriyama-shi (JP)

Correspondence Address: BIRCH, STEWART, KOLASCH & BIRCH, LLP, P.O. Box 747, Falls Church, VA, 22040-0747, US

(21) Appl. No.: 09/783,100

(22) Filed: Feb. 15, 2001

(30) Foreign Application Priority Data
Feb. 15, 2000 (JP) P2000-36048
Feb. 15, 2000 (JP) P2000-36049
Mar. 1, 2000 (JP) P2000-55165

(51) Int. Cl. H04M 15/00

(52) U.S. Cl. 379/114.02; 379/114.03

(57) ABSTRACT

An object of the invention is to make operating a center from a neutral standpoint pay financially in a communication system that enables communications to be initiated by selecting the lowest cost communication line from among a plurality of communication lines. When communication apparatus B accesses center apparatus A by making a call to the center and transmits a filled out application form as an image signal, the center apparatus A prepares an optimum least cost routing table based on the calling party information received at the time of the call arrival and on the information read from the application form restored from the image signal, and transmits the thus prepared least cost routing table to the communication apparatus B.

### BACKGROUND OF THE INVENTION

1. Field of the Invention

The present invention relates to a communication system, a communication apparatus and a center apparatus that enable communications to be initiated by selecting a lowest cost communication line from among a plurality of communication lines, and also relates to a method for downloading a least cost routing (LCR) table.

2. Description of the Related Art

There are known conventional communication apparatuses that enable communications to be initiated by selecting a desired communication line from among a plurality of communication lines. Some of such apparatuses are equipped with a least cost routing function, in which, at a time of making a call, the lowest cost communication line is automatically selected based on an LCR table in which costs are stored for different communication lines available for routing, and the number for using the selected communication line is added to the telephone number entered from the user in dialing.

As to a system having an LCR function, telephone communication carriers (corporations that own communication lines and provides communication services for subscribers) operate a center having a center apparatus, which center accesses a communication apparatus equipped with an LCR function and downloads the latest LCR table to the communication apparatus.

However, when the center-operating corporation is a telephone communication carrier, as in the above conventional system, there arises the problem that the communication line that is actually of the lowest cost may not be selected, because the number of communication lines available for selection is small, or because the LCR table is prepared in such a manner that the communication line owned by the center-operating corporation is used as often as possible. On the other hand, even when the center-operating corporation is a telephone communication carrier, if the LCR table is prepared from a neutral standpoint by increasing the number of communication lines available for selection, it sure becomes possible to select the communication line that is actually of the lowest cost, but in this case, when an access is made from a subscriber's communication apparatus through a communication line, the center apparatus once disconnect the subscriber's communication apparatus from the communication line and from the center side an access is made to the subscriber's communication apparatus to download the LCR table thereto, which causes the problem that operating the center does not pay financially because the communication cost for downloading the LCR table cannot be collected from the subscriber.

When a corporation that is not a telephone communication carrier operates the center, the communication line that is actually of the lowest cost can be selected since the LCR table can be prepared from a neutral standpoint, but here again, there arises the problem that operating the center does not pay financially because the burden of communication costs for loading the LCR table significantly affects the operating costs as a business corporation.

### SUMMARY OF THE INVENTION

It is an object of the invention to provide a communication system, a communication apparatus, a center apparatus, capable of making a center be operated from a neutral standpoint and a method for downloading an LCR table.

The invention provides a communication system comprising a center apparatus in which an LCR table containing communication cost information for each communication line is stored; and a communication apparatus for selecting a communication line to be used based on the LCR table, wherein when the communication apparatus accesses the center apparatus, the LCR table is downloaded to the communication apparatus.

According to the invention, when the communication apparatus accesses the center apparatus, the center apparatus downloads the LCR table to the communication apparatus without once disconnecting the communication apparatus from the communication line, thereby enabling the LCR table prepared by the center apparatus to be downloaded to the communication apparatus without the need for the LCR table provider which provides the LCR table from the center apparatus to bear the communication cost for downloading the LCR table. Since this eliminates the need to collect the communication cost for downloading the LCR table, the business for providing the LCR table from a neutral standpoint can be made to pay financially. Accordingly the least cost communication line can be selected using the LCR table prepared from a neutral standpoint.

In the invention it is preferable that the center apparatus selects or prepares the LCR table based on calling party information that is reported when an access occurs from the communication apparatus thereto, and downloads the thus selected or prepared LCR table to the communication apparatus.

According to the invention, since the center apparatus is configured to select or prepare the LCR table based on the calling party information reported when the communication apparatus accesses the center apparatus, and to download the thus selected or prepared LCR table to the communication apparatus, the LCR table that matches the communication apparatus can be automatically downloaded to the communication apparatus in response to the access made from the communication apparatus. This enables smooth operation of the business providing the LCR table from the center apparatus.

The invention also provides a communication system comprising a center apparatus in which an LCR table containing communication cost information for each communication line is stored; a computer for downloading the LCR table from the center apparatus; and a communication apparatus for selecting a communication line to be used based on the LCR table transferred from the computer, wherein when the computer accesses the center apparatus, the center apparatus downloads the LCR table to the computer.

According to the invention, when an access from the computer is made to the center apparatus, the center apparatus downloads the LCR table to the computer in the communication line-maintaining condition, and the computer transfers the downloaded LCR table to the communication apparatus, thereby enabling the LCR table prepared by the center apparatus to be downloaded to the communication apparatus without the need for the LCR table provider to bear the communication cost for downloading the LCR table. Since this eliminates the need to collect the communication cost for downloading the LCR table, the business for providing the LCR table from a neutral standpoint can be made to pay financially. Accordingly the least cost communication line can be selected using the LCR table prepared from a neutral standpoint.

In the invention it is preferable that the center apparatus selects or prepares the LCR table based on information unique to the communication apparatus which information is transmitted from the communication apparatus or the computer, and downloads the thus selected or prepared LCR table to the communication apparatus or the computer.

According to the invention, since the center apparatus is configured to select or prepare the LCR table based on the information unique to the communication apparatus transmitted from the communication apparatus or the computer, and to download the thus selected or prepared LCR table to the communication apparatus or the computer, the LCR table that matches the communication apparatus can be automatically downloaded. This enables smooth operation of the business providing the LCR table from the center apparatus.

In the invention it is preferable that data concerning users using the center apparatus is provided to a telephone communication carrier through a network.

According to the invention, by providing the data concerning users using the center apparatus to a telephone communication carrier through a network, the LCR table provider which provides the LCR table from the center apparatus can urge the telephone communication carrier to reexamine communication costs or to develop new products.

The invention provides a communication apparatus comprising control means for accessing a center apparatus where an LCR table containing communication cost information for each communication line is stored, downloading the LCR table from the center apparatus to the communication apparatus and selecting a communication line to be used based on the downloaded LCR table.

According to the invention, since the control means accesses the center apparatus where the LCR table containing communication cost information for each communication line is stored and, while keeping the line connected, downloads the LCR table from the center apparatus, the LCR table provider need not bear the communication cost for downloading the LCR table. Since this eliminates the need to collect the communication cost for downloading the LCR table, the business for providing the LCR table from a neutral standpoint can be made to pay financially, and besides, the user can select communication lines by using the LCR table prepared from a neutral standpoint.

The invention also provides a communication apparatus comprising:

control means for accessing a center apparatus, and allowing an LCR table containing communication cost information for each communication line stored in the central apparatus to be downloaded to a computer, receiving the LCR table through the computer to which the LCR table has been downloaded, and selecting a communication line to be used based on the thus received LCR table.

According to the invention, since the center apparatus is accessed where the LCR table containing communication cost information for each communication line is stored and, while keeping the line connected, the LCR table is downloaded from the center apparatus, and since the control means is configured to receive the LCR table transferred from the computer, the LCR table provider need not bear the communication cost for downloading the LCR table. Since this eliminates the need to collect the communication cost for downloading the LCR table, the business for providing the LCR table from a neutral standpoint can be made to pay financially, and besides, the user can select communication lines by using the LCR table prepared from a neutral standpoint.

In the invention it is preferable that the control means determines timing of making an access to the center apparatus based on time and date data included in the LCR table, and the center apparatus is accessed with the thus determined timing to download the LCR table from the center apparatus.

According to the invention, since the control means determines the timing for accessing the center apparatus based on time and date data included in the LCR table, and a LCR table is downloaded from the center apparatus by making an access with the thus determined timing, the latest LCR table prepared by the center apparatus can be downloaded at an appropriate time without the need for the LCR table provider to bear the communication cost for downloading the LCR table.

In the invention it is preferable that when contents of the LCR table are lost, the control means detects the contents having been lost, and accesses the center apparatus to download the LCR table from the center apparatus.

According to the invention, when the contents of the LCR table are lost, the control means detects the contents having been lost, and accesses the center apparatus to download the LCR table from the center apparatus. Accordingly, calls can always be made using the LCR function.

The invention provides a center apparatus comprising:

LCR data management means for maintaining an LCR table containing communication cost information for each communication line; and control means for, in response to an access of a communication apparatus or computer to the center apparatus, allowing the LCR table to be downloaded to the communication apparatus or computer while keeping a line connected.

According to the invention, since the control means is configured to maintain the LCR table containing communication cost information for each communication line, and to download LCR data to the communication apparatus or the computer when the communication apparatus or the computer accesses the center apparatus, the LCR table provider need not bear the communication cost for downloading the LCR table.

In the invention it is preferable that the control means selects or prepares an LCR table based on calling party information that is reported when the center apparatus is accessed by the communication apparatus, and downloads the thus selected or prepared LCR table to the communication apparatus.

According to the invention, since the control means in the center apparatus is configured to select or prepare the LCR table based on the calling party information reported when the center apparatus is accessed by the communication apparatus, and to download the thus selected or prepared LCR table to the communication apparatus, the LCR table that matches the communication apparatus can be automatically downloaded to the communication apparatus in response to the access of the communication apparatus to the center apparatus.

In the invention it is preferable that the control means selects or prepares the LCR table based on information unique to the communication apparatus transmitted from the communication apparatus or the computer, and downloads the thus selected or prepared LCR table to the communication apparatus or the computer.

According to the invention, since the control means in the center apparatus is configured to select or prepare the LCR table based on the information unique to the communication apparatus transmitted from the communication apparatus or the computer, and to download the thus selected or prepared LCR table to the communication apparatus or the computer, the LCR table that matches the communication apparatus can be automatically downloaded.

The invention further provides a method for downloading an LCR table comprising:

a step of, when a communication apparatus or computer accesses a center apparatus in which an LCR table containing communication cost information for each communication line is stored, downloading the LCR table to the communication apparatus or computer while keeping a communication line connected.

According to the invention, since the LCR table is downloaded to the communication apparatus or the computer when the communication apparatus or computer accesses to the center apparatus, the cost for downloading the LCR table can be charged to the user of the communication apparatus or the computer.

The invention provides a communication system comprising: a center apparatus in which an LCR table containing communication cost information for each communication line is stored; and a communication apparatus for selecting a communication line to be used based on the LCR table downloaded from the center apparatus to the communication apparatus, wherein when the communication apparatus accesses the center apparatus, the LCR table to which a center telephone number is appended is downloaded from the center apparatus to the communication apparatus, and in subsequent accesses of the communication apparatus to the center apparatus the communication apparatus uses the center telephone number appended to the LCR table.

According to the invention, when the center apparatus is accessed by the communication apparatus, the LCR table to which the center telephone number is appended is downloaded from the center apparatus to the communication apparatus, while keeping the communication line connected, and the communication apparatus selects the communication line to be used based on the downloaded LCR table, and accesses the center apparatus by using the center telephone number appended to the LCR table. Accordingly, the LCR table provider need not bear the communication cost for downloading the LCR table, and further, any change in the center telephone number can be notified to the communication apparatus.

Furthermore, since there is no need to collect the communication cost for downloading the LCR table, the business for providing the LCR table from a neutral standpoint can be made to pay financially.

In the case where an LCR table is downloaded when the communication apparatus accesses the center apparatus, there arises the problem that access from the communication apparatus to the center apparatus requires a complex procedure when the center telephone number is changed, for example, because the center is moved. However, according to the invention, since the center telephone number is appended to the LCR table downloaded from the center to the communication apparatus, and the communication apparatus accesses the center by using this appended center telephone number, the LCR table can be downloaded by accessing from the communication apparatus without requiring a complex procedure even when the center telephone number is changed, for example, because the center is moved.

The invention provides a communication apparatus comprising control means to which an LCR table containing communication cost information for each communication line stored in a center apparatus is downloaded in response to the access to the center apparatus, for selecting a communication line to be used based on the thus received LCR table,

wherein in subsequent accesses of the control means to the center apparatus the control means uses the center telephone number appended to the LCR table.

According to the invention, since the control means accesses the center apparatus where the LCR table containing communication cost information for each communication line is stored and, while keeping the line connected, downloads the LCR table from the center apparatus, and since the control means selects the communication line to be used based on the downloaded LCR table, and accesses the center apparatus by using the center telephone number contained in the LCR table, the LCR table provider need not bear the communication cost for downloading the LCR table, and further, any change in the center telephone number can be recognized at the communication apparatus side.

In the invention it is preferable that the control means compares a pre-registered center telephone number with calling party information reported when an access is received, and when the access is judged as being from the center apparatus, upon termination of the access request the control means accesses the center apparatus and the LCR table is downloaded to the control means from the center apparatus.

According to the invention, the control means compares the pre-registered center telephone number with the calling party information reported when an access is received and, when the access is judged as being from the center apparatus, upon termination of the access request the control means accesses the center apparatus and the LCR table is downloaded to the control means from the center apparatus. As a result, the LCR table provider need not bear the communication cost for downloading the LCR table.

In the invention it is preferable that as a result of the comparison between the pre-registered center telephone number and the calling party information reported when an access is received, when the access is judged as being from the center apparatus, the control means does not execute a call arrival alerting operation or a call receiving operation.

According to the invention, as the result of the comparison between the pre-registered center telephone number and the calling party information reported when an access is received, when the access is determined as being from the center apparatus, the control means controls so that a call arrival alerting operation or a call receiving operation will not be executed, thereby preventing the LCR table provider from being charged for the communication cost as the result of an erroneous operation, etc.

In the invention it is preferable that when the center telephone number and valid time information is appended to the LCR table, before the valid time the control means accesses the center apparatus by using the existing center telephone number, and after the valid time is reached, the control means accesses the center apparatus by using the center telephone number appended to the LCR table.

According to the invention, when valid time data is attached to the center telephone number appended to the LCR table, before the valid time the control means accesses the center apparatus by using the existing center telephone number, and after the valid time is reached, the control means accesses the center apparatus by using the center telephone number appended to the LCR table; as a result, accesses to the center apparatus can be made correctly, irrespective of the update time of the LCR table.

Furthermore, at the center apparatus side, there is no need to update many LCR table in a short period of time, and this serves to promote smooth operation of the business that provides the LCR table from the center apparatus.

The invention further provides a method for downloading an LCR table comprising a step of, when a communication apparatus accesses a center apparatus where an LCR table containing communication cost information for each communication line is stored, downloading the LCR table with a center telephone number appended thereto, to the communication apparatus.

According to the invention, since the LCR table is downloaded to the communication apparatus or the computer while keeping the communication line connected when the communication apparatus or the computer accesses, the cost for downloading the LCR table can be charged to the user of the communication apparatus or the computer, and further, any change in the center telephone number can be notified to the communication apparatus.

The invention provides a communication system comprising a center apparatus in which an LCR table containing communication cost information for each communication line is stored; and a communication apparatus for selecting a communication line to be used based on the LCR table, wherein the center apparatus downloads to the communication apparatus a plurality of LCR tables with valid time information appended thereto, and wherein based on the valid time information appended to the plurality of downloaded LCR tables, the communication apparatus selects an LCR table to be used for the line selection from among the plurality of downloaded LCR tables.

Thus, according to the invention, the center apparatus downloads to the communication apparatus a plurality of LCR tables with valid time information appended thereto and, based on the valid time information appended to the plurality of downloaded LCR tables, the communication apparatus determines the LCR table to be used for the line selection, and selects the communication line to be used based on the thus determined LCR table. In this way, with a single download operation, the line selection function using LCR tables can be maintained for a long period of time.

Accordingly, the communication cost for downloading LCR tables can be reduced.

The invention also provides a communication system comprising a center apparatus in which an LCR table containing communication cost information for each communication line is stored; and a communication apparatus for selecting a communication line to be used based on the LCR table, wherein the LCR table containing information about a new communication line scheduled to be implemented is downloaded from the center apparatus to the communication apparatus, and wherein the communication apparatus determines whether the new communication line is available for service, and performs a line selection to be used based on the downloaded LCR table from which the new communication line information is excluded when the new communication line is not yet available for service, or in which table the new communication line information is kept when the new communication line is available for service.

Thus, according to the invention, the center apparatus downloads to the communication apparatus an LCR table containing information about a new communication line expected to be opened, and the communication apparatus determines whether the new communication line is available for service, and performs a line selection based on the LCR table by excluding information of the new communication line if the new communication line is not yet available for service, or by including information of the new communication line if the new communication line is available for service. In this way, with a single download operation, the line selection function using the LCR table can be maintained for a long period of time. Accordingly, the communication cost for downloading LCR tables can be reduced.

The invention further provides a communication system comprising a center apparatus in which an LCR table containing communication cost information for each communication line is stored; and a communication apparatus for selecting a communication line to be used based on the LCR table, wherein from the center apparatus to the communication apparatus is downloaded the LCR table with information indicating that the LCR table is for a demonstration purpose appended thereto, and wherein the communication apparatus is able to change the demonstration indicating information and, as long as the demonstration indicating information is appended to the LCR table, the communication apparatus does not execute a line selection based on the LCR table but displays a communication cost for an actually used communication line along with a communication cost for a communication line that would be selected if the demonstration LCR table were used, and after the demonstration indicating information is changed, the communication apparatus performs a line selection based on the LCR table whose appended information has been changed.

According to the invention, the center apparatus downloads the LCR table to the communication apparatus table by appending thereto information indicating that the LCR table is for demonstration purposes for the calculation of communication costs, and as long as the demonstration indicating information is appended to the LCR table, the communication apparatus does not execute a line selection based on the LCR table but displays the communication cost for the actually used communication line along with the communication cost for the communication line that would be selected if the demonstration LCR table were used, and after the demonstration indicating information is changed, the communication apparatus performs a line selection based on the LCR table whose appended information has been changed; in this way, the demonstration function and line selection function using the LCR table can be achieved with a single download operation.

This not only helps to promote new subscriptions to the LCR service, but also serves to reduce the communication costs for downloading LCR tables.

In the invention it is preferable that when the center apparatus is accessed by the communication apparatus, the LCR table is downloaded from the center apparatus to the communication apparatus while keeping the communication line connected.

Thus, according to the invention, since the center apparatus is configured to download the LCR table to the communication apparatus when the communication apparatus accesses the center apparatus, the communication cost for downloading the LCR table can be charged to the communication apparatus side, thus alleviating the burden of communication costs at the LCR table provider.

The invention provides a communication apparatus comprising control means for accessing a center apparatus where an LCR table containing communication cost information for each communication line is stored, downloading a plurality of LCR tables with valid time information appended thereto from the center apparatus to the communication apparatus, and selecting a communication line to be used based on the downloaded LCR tables, wherein the control means selects the LCR table to be used for the line selection, based on the valid time information appended to the LCR tables.

Thus, according to the invention, from the plurality of LCR tables downloaded from the center apparatus, the LCR table to be used for the line selection is determined based on the valid time information appended to the LCR tables, and the communication line to be used is selected based on the thus determined LCR table; in this way, with a single download operation, the line selection function using the LCR tables can be maintained for a long period of time.

The invention also provides a communication apparatus comprising control means for accessing a center apparatus where an LCR table containing communication cost information for each communication line is stored, downloading an LCR table containing information about a new communication line scheduled to be implemented from the center apparatus to the communication apparatus, and selecting a communication line to be used based on the downloaded LCR table, wherein the control means determines whether a new communication line is available for service, and performs a line selection based on the LCR table from which the new communication line information is excluded when the new communication line is not yet available for service, or from which the new communication line information is not excluded when the new communication line is available for service.

According to the invention, whether the new communication line included in the LCR table downloaded from the center apparatus is available for service is determined, the line selection is executed based on the LCR table from which the new communication line information is excluded when the new communication line is not yet available for service, or from which the new communication line information is not excluded when the new communication line is available for service. In this way, with a single download operation, the line selection function using the LCR table can be maintained for a long period of time.

The invention further provides a communication apparatus comprising control means for accessing a center apparatus where an LCR table containing communication cost information for each communication line is stored, downloading from the center apparatus the LCR table with information indicating that the LCR table is for a demonstration purpose, appended thereto, the control means being capable of changing demonstration-indicating information, wherein as long as the demonstration-indicating information is appended to the LCR table, the control means does not execute a line selection based on the LCR table but displays a communication cost for an actually used communication line along with a communication cost for a communication line that would be selected if the demonstration LCR table were used, and when the demonstration-indicating information is changed, the control means carry out a line selection based on the LCR table whose appended information has been changed.

According to the invention, as long as the demonstration indicating information is appended to the LCR table downloaded from the center apparatus, the line selection based on the LCR table is not executed but the communication cost for the actually used communication line is displayed along with the communication cost for the communication line that would be selected if the demonstration LCR table were used, and after the demonstration indicating information is changed, the line selection is executed based on the LCR table whose appended information has been changed. In this way, the demonstration function and line selection function using the LCR table can be achieved with a single download operation.

The invention provides a method for downloading an LCR table comprising a step of, when a communication apparatus accesses a center apparatus where a plurality of LCR tables containing communication cost information for each communication line are stored, downloading the plurality of LCR tables along with valid time data appended thereto, to the communication apparatus, wherein the communication apparatus selects an LCR table to be used for line selection from among the plurality of downloaded LCR tables based on the valid time data appended thereto.

Thus, according to the invention, a plurality of LCR tables with valid time data appended thereto are downloaded from the center apparatus to the communication apparatus which selects an LCR table to be used for line selection from among the plurality of downloaded LCR tables based on the valid time data appended to the LCR tables. Accordingly, the line selection function using the LCR tables can be maintained for a long period of time.

The invention also provides a method for downloading an LCR table comprising a step of, when a communication apparatus accesses a center apparatus where an LCR table containing communication cost information for each communication line is stored, downloading the LCR table including information about a new communication line scheduled to be implemented, to the communication apparatus, wherein when the new communication line is not yet available for service, the communication apparatus executes a line selection to be used based on the downloaded LCR table from which the information about the new communication line is excluded, and when the new communication line is available for service, the communication apparatus executes a line selection to be used based on the downloaded LCR table in which the information about the new communication line is included.

Thus, according to the invention, the LCR table containing information about a new communication line scheduled to be implemented is downloaded from the center apparatus to the communication apparatus which performs a line selection to be used based on the downloaded LCR table from which the new communication line information is excluded when the new communication line included in the downloaded LCR table is not yet available for service, or in which the new communication line information is kept when the new communication line is available for service. Accordingly, the line selection function using the LCR table can be maintained for a long period of time.

The invention further provides a method for downloading a least cost routing table comprising:

a step of, when a communication apparatus accesses a center apparatus where a least cost routing table containing communication cost information for each communication line is stored, downloading from the center apparatus to the communication apparatus a least cost routing table with information indicating that the least cost routing table is for a demonstration purpose, appended thereto,

wherein the communication apparatus is able to change the demonstration indicating information, and as long as the demonstration indicating information is appended to the least cost routing table, the communication apparatus does not execute a line selection based on the least cost routing table but displays a communication cost for an actually used communication line along with a communication cost for a communication line that would be selected when the demonstration least cost routing table were used, and after the demonstration indicating information is changed, the communication apparatus performs a line selection based on the least cost routing table whose appended information has been changed.

Thus, according to the invention, the center apparatus downloads the LCR table with the demonstration indicating information appended thereto, to the communication apparatus which, as long as the demonstration indicating information is appended to the downloaded LCR table, does not execute the line selection based on the LCR table but displays the communication cost for the actually used communication line along with the communication cost for the communication line that would be selected when the demonstration LCR table were used, and which, after the demonstration indicating information is changed, performs the line selection based on the LCR table whose appended information has been changed; in this way, the demonstration function and line selection function using the LCR table can be achieved with a single download operation.

### BRIEF DESCRIPTION OF THE DRAWINGS

Other and further objects, features, and advantages of the invention will be more explicit from the following detailed description taken with reference to the drawings wherein:

FIG. 1 is an explanatory diagram showing an overview of a communication system according to one embodiment of the invention;

FIG. 2 is a functional block diagram showing the configuration of a center apparatus used in the communication system of FIG. 1;

FIG. 3 is a functional block diagram showing the configuration of a facsimile apparatus as one example of a communication apparatus used in the communication system of FIG. 1;

FIG. 4 is a functional block diagram showing the configuration of a home computer used in the communication system of FIG. 1;

FIG. 5 is a sequence diagram illustrating a control procedure for user registration using a communication line D in the communication system of FIG. 1;

FIG. 6 is an explanatory diagram showing one example of an application form for user registration in the communication system of FIG. 1;

FIG. 7 is a flow chart illustrating a control procedure for user registration using a large-scale network E in the communication system of FIG. 1;

FIGS. 8A to 8G are explanatory diagrams showing display examples of registration screens displayed on a display device 309 of a computer C during the user registration using the large-scale network E;

FIG. 9 is a flow chart illustrating the control procedure executed when transferring an LCR table, downloaded to the computer C at the time of the user registration using the large-scale network E, to the communication apparatus B via a small-scale network F;

FIG. 10 is a sequence diagram illustrating a control procedure when transferring the LCR table from the computer C to the communication apparatus B by using the small-scale network F;

FIGS. 11A to 11D are explanatory diagrams showing display examples of LCR table transfer screens displayed when transferring the LCR table from the computer C to the communication apparatus B by using the small-scale network F;

FIG. 12 is a flow chart illustrating the control procedure executed at the time of LCR table updating using the communication line D in the communication system of FIG. 1;

FIG. 13 is an explanatory diagram illustrating a telephone numbering scheme used in the United States;

FIG. 14 is a diagram showing one example of an LCR table format;

FIG. 15 is an explanatory diagram showing one example of LCR table update timing; and

FIG. 16 is an explanatory diagram showing another example of LCR table update timing.

### DETAILED DESCRIPTION OF THE PREFERRED EMBODIMENTS

Now referring to the drawings, preferred embodiments of the invention are described below.

A communication system according to one embodiment of the invention will be described below with reference to drawings.

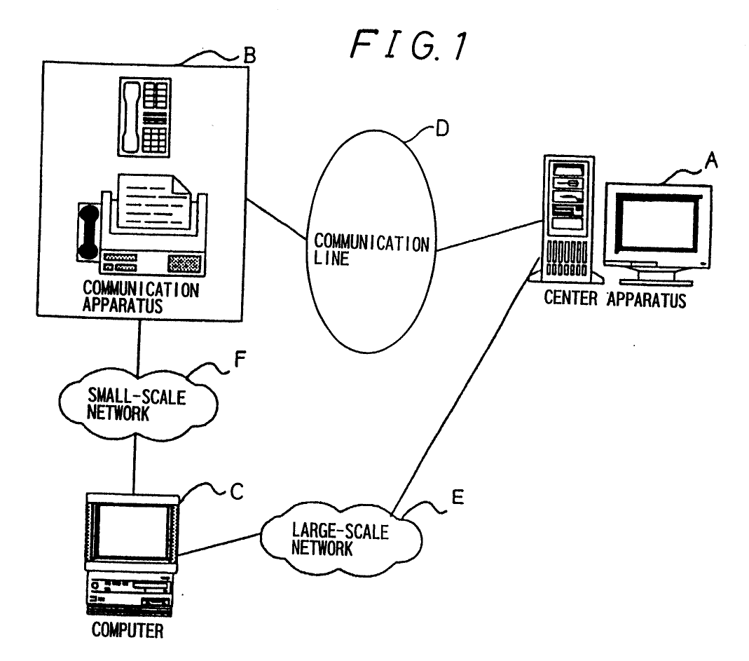

FIG. 1 is an explanatory diagram showing an overview of a communication system according to one embodiment of the invention. In FIG. 1, reference character A is a center apparatus, B is a communication apparatus (for example, a telephone or facsimile apparatus), and C is a home computer. The center apparatus A and the communication apparatus B are interconnected via a communication line D such as a PSTN (Public Switched Telephone Network) or ISDN. (Integrated Services Digital Network), the center apparatus A and the computer C are interconnected via a large-scale network E such as the Internet, and the communication apparatus B and the computer C are interconnected via a small-scale network F such as a home LAN.

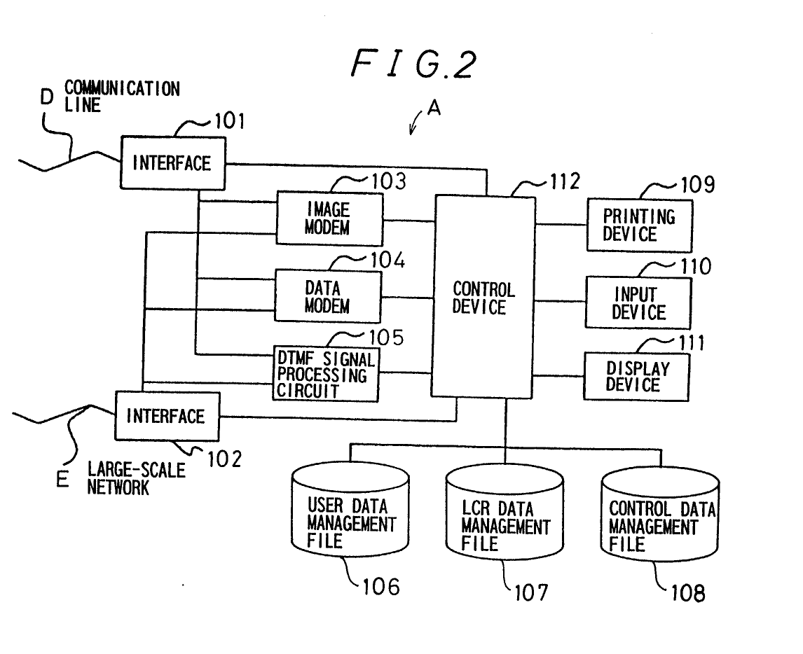

FIG. 2 is a functional block diagram showing the configuration of the center apparatus A in FIG. 1. In FIG. 2, reference numeral 101 is an interface for connecting to the communication line D, and for monitoring the condition of the communication line D; 102 is an interface for connecting to the large-scale network E, and for monitoring the condition of the large-scale network E; 103 is an image modem for modulating image data into an analog signal suitable for transmission over the communication line D or the large-scale network E, and for demodulating an analog signal, received via the communication line D or the large-scale network E, back into image data; 104 is a data modem for demodulating data signals such as calling party information contained in a calling signal; 105 is a DTMF (Dual Tone Multi Frequency) signal processing circuit for converting prescribed data into a DTMF signal suitable for transmission over the communication line D or the large-scale network E, and for detecting the DTMF signal received via the communication line D or the large-scale network E; 106 is a user data management file for storing and managing user data obtained via the communication line D or the large-scale network E; 107 is an LCR data management file for storing and managing an LCR table containing communication cost information for each communication line; 108 is a control data management file for storing and managing image data for facsimile, voice data for telephone, program data for the Internet (home page), control program data, etc.; 109 is a printing device for printing image data on a prescribed sheet; 110 is an input device for performing various input operations; 111 is a display device for displaying various conditions and states; and 112 is a control device for controlling various parts.

The interfaces 101 and 102, the image modem 103, the data modem 104, the DTMF signal processing circuit 105, the user data management file 106, the LCR data management file 107, the control data management file 108, the printing device 109, the input device 110, the display device 111, and the control device 112 together constitute the center apparatus A. The thus constituted center apparatus A is constructed to prepare a list by extracting desired data from the user data stored in the user data management file 106 in accordance with a program stored in the control data management file 106, to transmit the LCR table, stored in the LCR data management file 107 acting as LCR data management means, onto the communication line D or the large-scale network E, and to operate a home page on the large-scale network E.

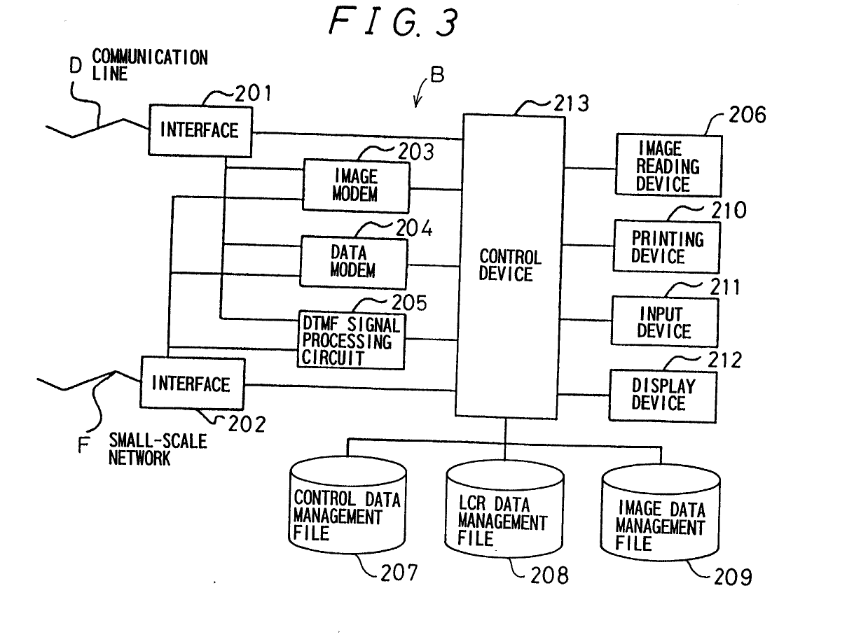

FIG. 3 is a functional block diagram showing the configuration of a facsimile apparatus as one example of the communication apparatus B in FIG. 1. In FIG. 3, reference numeral 201 is an interface for connecting to the communication line D, and for monitoring the condition of the communication line D; 202 is an interface for connecting to the small-scale network F, and for monitoring the condition of the small-scale network F; 203 is an image modem for modulating image data into an analog signal suitable for transmission over the communication line D or the small-scale network F, and for demodulating an analog signal, received via the communication line D or the small-scale network F, back into image data; 204 is a data modem for demodulating data signals such as calling party information contained in a calling signal; 205 is a DTMF signal processing circuit for converting prescribed data into a DTMF signal suitable for transmission over the communication line D or the small-scale network F, and for detecting the DTMF signal received via the communication line D or the small-scale network F; and 206 is an image reading device for reading image data from a document, the image reading device being constructed from a combination of a lens and a CCD (Charge Coupled Device) line sensor or from a contact sensor using a rod lens array.

Further, reference numeral 207 is a control data management file for storing and managing control program data, etc.; 208 is an LCR data management file for storing and managing an LCR table obtained via the communication line D or the small-scale network F; 209 is an image data management file for storing and managing image data received via the communication channel D and demodulated by the image modem 202, image data received from the small-scale network F via the interface 205, and image data read by the image reading device 206; and 210 is a printing device for printing on a prescribed sheet an image prepared based on the image data stored in the image data management file 209, the printing device being, in many cases, constructed from a thermal printer, an electrophotographic printer, or an inkjet printer. Reference numeral 211 is an input device for performing various input operations; 212 is a display device for displaying various conditions and states; and 213 is a control device for controlling various parts.

The interfaces 201 and 202, the image modem 203, the data modem 204, the DTMF signal processing circuit 205, the image reading device 206, the control data management file 207, the LCR data management file 208, the image data management file 209, the printing device 210, the input device 211, the display device 212, and the control device 213 together constitutes the facsimile apparatus as one example of the communication apparatus B. In the thus constituted facsimile apparatus, when a dialing operation is executed on the input device 211, the control device 213 searches the LCR data management file 208 based on the telephone number dialed and the current time provided by the built-in timer function, selects the lowest cost communication line from the corresponding LCR table, and supplies the dialing data created, for example, by appending the number necessary to use the selected communication line, to the DTMF signal processing circuit 204 which then converts it into a DTMF signal and sends it out on the communication line D via the interface 201.

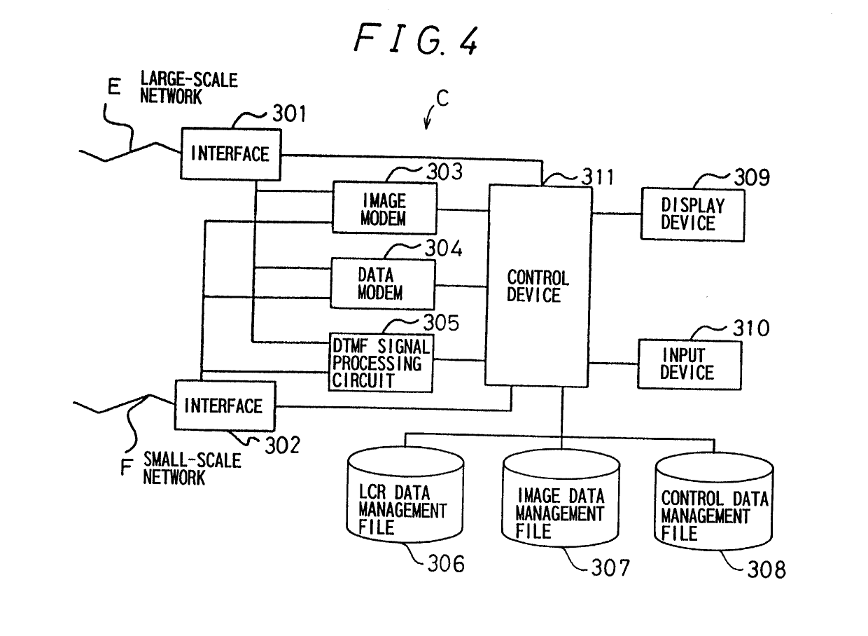

FIG. 4 is a functional block diagram showing the configuration of a home personal computer as one example of the computer C in FIG. 1. In FIG. 4, reference numeral 301 is an interface for connecting to the large-scale network E, and for monitoring the condition of the large-scale network E; 302 is an interface for connecting to the small-scale network F, and for monitoring the condition of the small-scale network F; 303 is an image modem for modulating image data into an analog signal suitable for transmission over the large-scale network E or the small-scale network F, and for demodulating an analog signal, received via the large-scale network E or the small-scale network F, back into image data; 304 is a data modem for demodulating data signals; 305 is a DTMF signal processing circuit for converting prescribed data into a DTMF signal suitable for transmission over the large-scale network E or the small-scale network F, and for detecting the DTMF signal received via the large-scale network E or the small-scale network F; 306 is an LCR data management file for storing and managing LCR data obtained via the large-scale network E; 307 is an image data management file for storing and managing the image data received from the large-scale network E or the small-scale network F; 308 is a control data management file for storing and managing control program data, etc.; 309 is a display device for displaying various conditions and states as well as images created based on the image data stored in the image data management file; 310 is an input device for performing various input operations; and 311 is a control device for controlling various parts.

The interfaces 301 and 302, the image modem 303, the data modem 304, the DTMF signal processing circuit 305, the LCR data management file 306, the image data management file 307, the control data management file 308, the display device 309, the input device 310, and the control device 311 together constitutes the computer C. In the thus constituted computer, when instructed from the input device 310 to print out the image displayed on the display device 309, the control device 311 searches the image data management file 307 and transmits the corresponding image data onto the small-scale network F via the interface 302; on the other hand, when instructed from the input device 310 to capture an image from some other device connected to the small-scale network F, the control device 311 captures via the interface 302 the image data output on the small-scale network F, and stores the data in the image data management file 307.

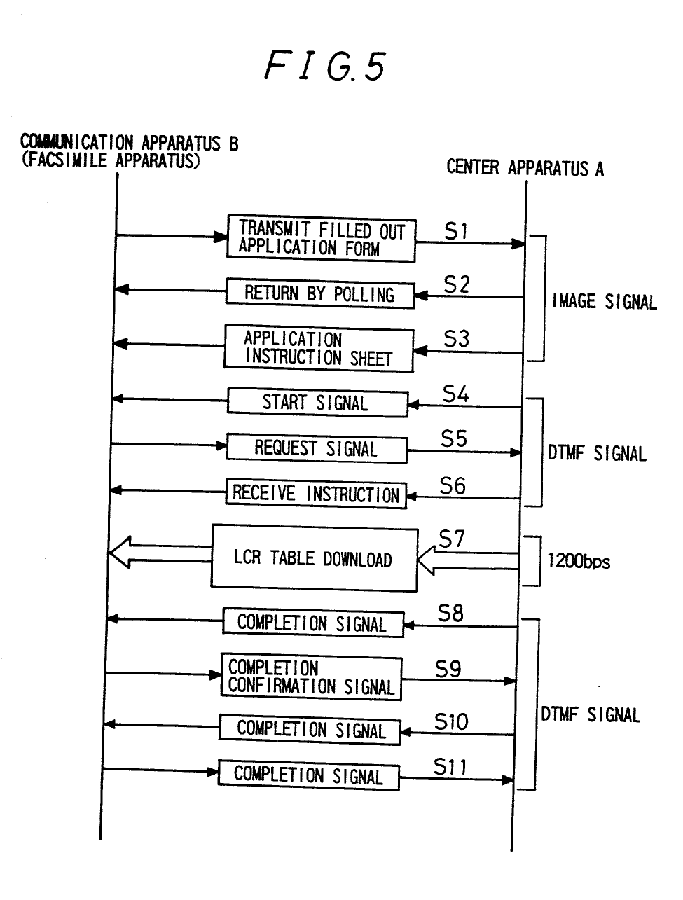

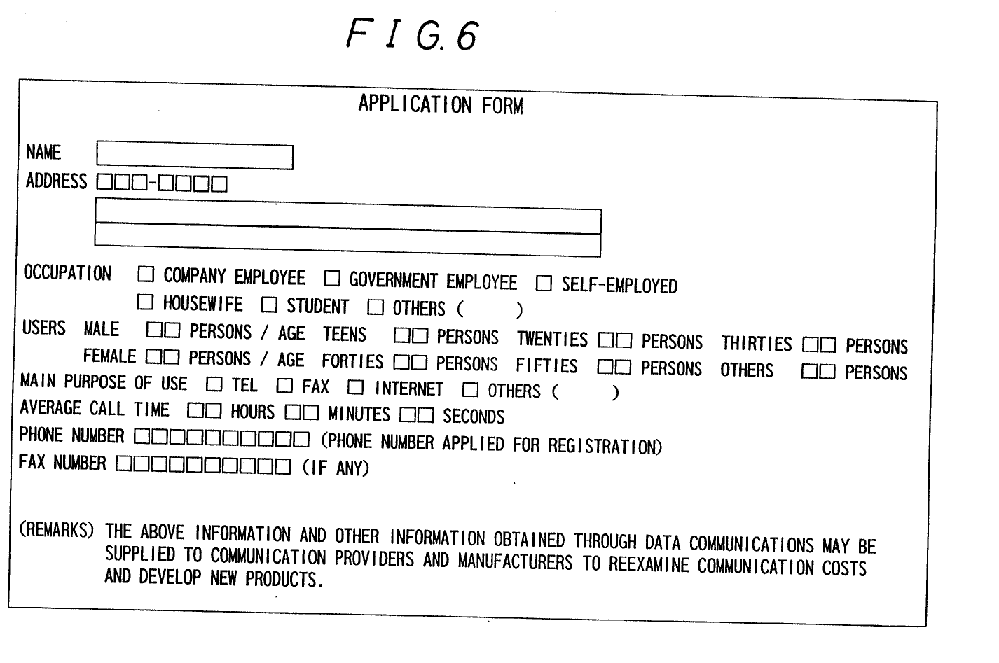

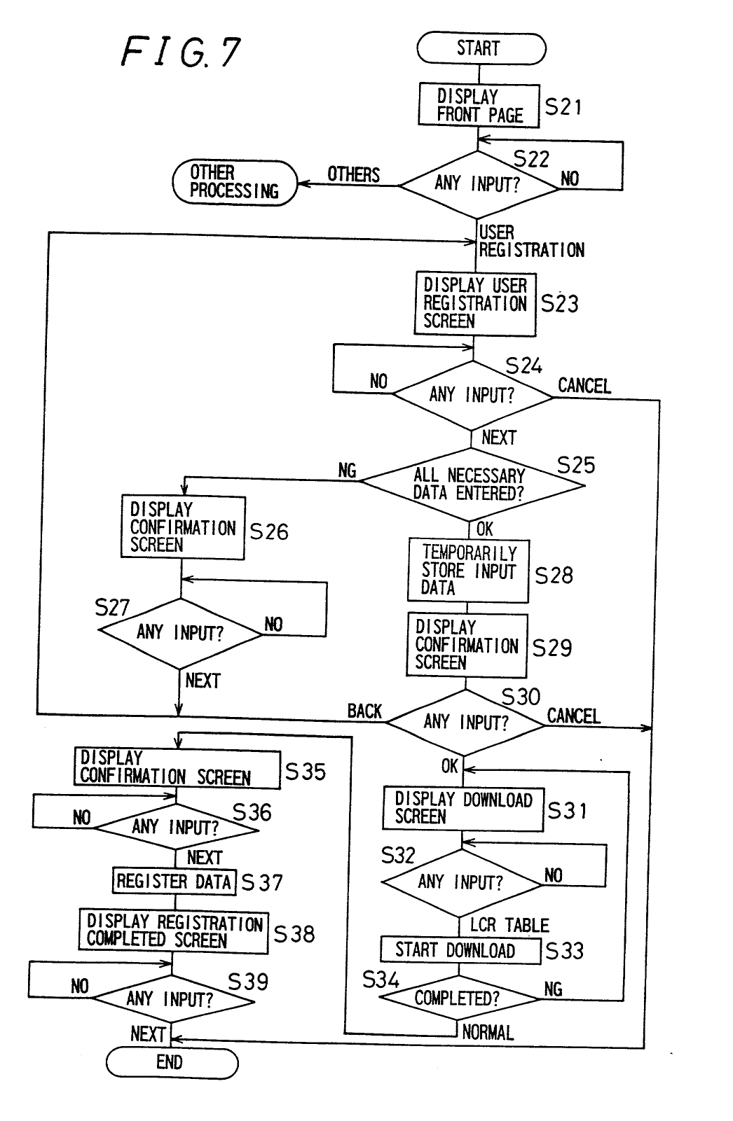

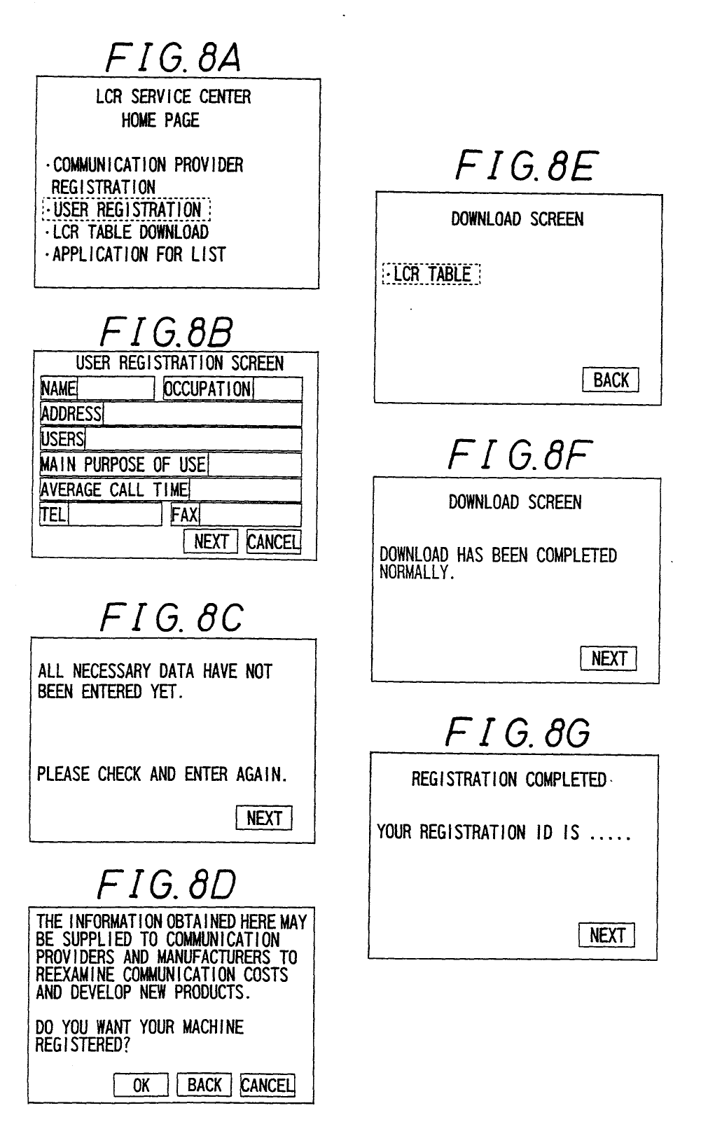

A procedure for user registration using the communication line D will be described with reference to FIGS. 5 and 6. FIG. 5 is a sequence diagram illustrating the control procedure for user registration using the communication line D in the communication system of FIG. 1, and FIG. 6 is an explanatory diagram showing one example of an application form for user registration.

After filling out the application form which carries entries, such as the name, address, occupation, user data, main purpose of use, average call time, etc., and a message warning that the obtained information may be supplied to communication providers and manufacturers, as shown in FIG. 6, the user initiates a call using the facsimile apparatus B to access the center apparatus A, has the filled out application form read by the image reading device 206, and transmits the application form by converting it to an image signal via the image modem 203 (step S1). The center apparatus A that received the image signal transmits the received image signal back to the communication apparatus B (facsimile apparatus) that was placed in the polling mode after transmission of the application form to enable it to be called from the center apparatus A (step S2). At the same time, the center apparatus A temporarily stores in the user data management file 106 the calling party information received at the time of the call arrival and the information read from the application form restored from the image signal, and thereafter converts an application instruction sheet indicating the acceptance of the application into an image signal and transmits it to the communication apparatus B (step S3).

As for the method of obtaining the application form, the application form may be enclosed in the product package or handed over to the user at the time of purchase, or provisions may be made so that the user can access the center apparatus A via the communication line D using the facsimile apparatus and have the application form transmitted to the facsimile apparatus by polling, or can access the center apparatus A via the large-scale network E using the computer C and have data downloaded or output as a hard copy.

After transmitting the application instruction sheet, the center apparatus A, while keeping the line connected, transmits a DTMF signal to the communication apparatus B as a start signal indicating the start of downloading of an LCR table (step S4). The communication apparatus B that received the start signal reads out the manufacturer name, model code, and serial number of the apparatus, the telephone number of the center, the current version number of the LCR table, the ID number, etc. from the control data management file 207, and transmits these pieces of information using DTMF signals to the center apparatus A as a request signal responding to the start signal (step S5).

The center apparatus A that received the request signal transmits a receive instruction to the communication apparatus B by using a DTMF signal (step S6) and, at the same time, temporarily stores the data contained in the request signal together with the data temporarily stored in the user data management file 106. Then, based on the temporarily stored data, the center apparatus A reads out the LCR table optimum for the requesting communication apparatus from the LCR data management file 107 or prepares an optimum LCR table by processing the readout LCR table, and transmits the thus readout or prepared LCR table to the communication apparatus B by including in it management data such as the version number of the LCR table, the telephone number of the center, update time, valid time, etc. (step S7).

Here, downloading (transmission) of the LCR table has the characteristic that as the transmission speed increases, the probability of data transmission error increases due to line noise, and as the transmission speed is reduced, it takes a longer time to download. Therefore, as a trade-off between them, a signaling rate of 800 bps to 2500 bps is desirable; further, since start-stop synchronization using a frequency modulation scheme of 1200 bps conforming to ITU-T recommendation V.23 is employed for the transmission of the calling party information received at the time of call arrival and is widely used for communication apparatuses B, the signaling rate of 1200 bps conforming to ITU-T recommendation V.23 is particularly desirable for the signals used when downloading the LCR table.

As for the update time data, since the center apparatus A overflows when many communication apparatuses B access simultaneously, download requests from the communication apparatuses B must be temporally evened out, and methods of evening out include, for example, a method in which the remainder of (last four digits of telephone number)×60÷1440 is distributed over 24 hours in one minute increments, or a method in which a call is placed after a random number (0 to 50)×5 minutes. In the case of distributing the remainder of (last four digits of telephone number×60)÷1440 over 24 hours in one minute increments, when a plurality of communication apparatuses B are connected to the same telephone number, since the start time of access to the center apparatus A is the same between them, an ID number should be assigned to each communication apparatus B and the remainder of (last four digits of telephone number+ID number×60)÷1440 should be distributed over 24 hours in one minute increments.

Furthermore, the number of LCR tables to be downloaded need not be limited to one that matches the average call time, but a plurality of LCR tables may be downloaded that match different call times (for example, a long call time, a short call time, etc.) or different periods (for example, a period before April and a period from April).

When a plurality of LCR tables that match different call times are downloaded, provisions should be made to have the user manually select an appropriate one when actually making a call using the communication apparatus B, or to automatically make a selection based on the average call time precalculated for each entered telephone number. When a plurality of LCR tables that match different periods are downloaded, provisions should be made to automatically make a selection based on the present time and date when actually making a call using the communication apparatus B.

The communication apparatus B that received the receive instruction switches its operation to the data modem 204 ready to receive the LCR, and when the LCR table transmitted from the center apparatus A is received, the received LCR table is stored in the LCR data management file 208, while the management data included in the LCR table is stored in the control data management file 207.

After that, the center apparatus A transmits a completion signal to the communication apparatus B by using a DTMF signal when the downloading of the LCR table is completed (step S8), and the communication apparatus B that received the completion signal returns a completion confirmation signal to the center apparatus A by using a DTMF signal (step S9). The center apparatus A that received the completion confirmation signal transmits a clear signal to the communication apparatus B by using a DTMF signal (step S10), and the communication apparatus B that received the clear signal transmits a clear signal to the center apparatus A by using a DTMF signal (step S11), thus terminating the application procedure. The line remains connected throughout the above process from step S1 to step S11.

Thus, according to the above control procedure, the user registration can be performing by accessing the center apparatus A from the communication apparatus B, and the optimum LCR table that matches the user's pattern of usage can be downloaded to the communication apparatus B used for the user registration, without once cutting the line, but by keeping the line connected, so that the communication cost can be charged to the user of the communication apparatus B.

The above control procedure has been described dealing with the case in which the application form is transmitted in the form of image data by using a facsimile apparatus as the communication apparatus, but the user registration using the communication line D is not limited to this particular example; for example, a telephone may be used as the communication apparatus B and the necessary entries in the application form may be transmitted using DTMF signals in such a manner as to answer an announcement transmitted from the center apparatus A.

Further, the above control procedure has been described dealing with the case in which the LCR table is downloaded to the communication apparatus B used for sending the application; alternatively, the LCR table may be downloaded to a communication apparatus B other than the apparatus used for sending the application. Furthermore, the application form may be sent by mail or like means.

For example, suppose the case where the user has both a telephone and a facsimile apparatus ready for use as the communication apparatus B, and the user sends in an application using the facsimile apparatus and has the LCR table downloaded to the telephone. In this case, the information read from the application form transmitted in the form of image data from the facsimile apparatus and the individually set user ID are temporarily stored in the user management file 106 (steps S1 and S2), and an application instruction sheet is transmitted as image data to the facsimile apparatus by including therein the user ID, the center's telephone number, and a message instructing the user to make a call to the center's telephone number from the communication apparatus B to which the user desires to have the LCR table downloaded, and to enter the user ID (step S3). When an access is made to the center's telephone number, and the user ID is entered, the remainder of the control procedure (from step S4 to step S11) is initiated by transmitting the start signal, based on the information corresponding to the user ID. This also applies to the case where the application form is sent by mail; in this case, the application instruction sheet may be sent by mail.

The above control procedure has been described dealing with the case in which the management data such as the version number, the center's telephone number, update time, valid time, etc. is included in the LCR table downloaded from the center apparatus A to the communication apparatus B, but the management data is not limited to this particular example. For example, when a new line is expected to be opened for the communication line D, the LCR table to be downloaded may be constructed by including therein the yet-to-be-opened line with a selection inhibit flag set for it so that the new line will not be selected until the new line becomes ready for service; in that case, the communication apparatus B makes a call to this flagged line every predetermined time to check whether it is available for service (this is checked by using the center's telephone number or a telephone number specified by the center apparatus A) and, when it is confirmed that the line is available for service, the selection inhibit flag is changed to the selection enable state so that the line selection can thereafter be executed by including the new line. At this time, the availability of the new line for service may be reported from the communication apparatus B to the center apparatus A.

Further, in the above control procedure, the LCR table is downloaded from the center apparatus A to the communication apparatus B at the time of user registration, and the communication apparatus B performs a line selection based on the downloaded LCR table, but the invention is not limited to this example. For example, when the availability of the new line for service is reported to the center apparatus A through a communication test, etc., an LCR table with a demonstration flag set for it, meaning that the LCR table is for demonstration purposes for the calculation of communication costs, may be downloaded from the center apparatus A to the communication apparatus B, and the communication cost that applies when the communication apparatus B performs a line selection based on the flagged LCR table may be displayed on the display device 212 for comparison with the actual communication cost; in this case, with the flagged LCR table already downloaded, when the user registration is performed, the flag of the already downloaded demonstration LCR table may be changed to the normal flag, eliminating the need to download a new LCR table and enabling the line selection thereafter to be executed based on the already downloaded LCR table.

Next, a procedure for user registration using the large-scale network E will be described with reference to FIGS. 7 and 8. FIG. 7 is a flow chart illustrating a control procedure for user registration when the user registration is performed using the large-scale network E, and FIGS. 8A to 8G are explanatory diagrams showing display examples of registration screens displayed on the display device 309 of the computer C during the user registration procedure of FIG. 7.

The center apparatus A operates its home page on the large-scale network E such as the Internet. When the computer C or communication provider D connected to the large-scale network E accesses the home page, a front page carrying “REGISTRATION OF COMMUNICATION PROVIDER” , “USER REGISTRATION”, “LCR TABLE DOWNLOAD”, and “APPLICATION FOR LIST” as separate buttons, such as shown in FIG. 8A, is displayed on the display device 309 of the computer C (step S21).

With this front page displayed, when the “USER REGISTRATION” button is clicked using the input device 310 of the computer C (step S22), the center apparatus A initiates the user registration procedure, whereupon a user registration screen, consisting of character strings indicating the name, address, occupation, user, main purpose of use, average call time, tel, fax, and E-mail, text boxes for entering these items, and buttons “NEXT” and “CANCEL”, such as shown in FIG. 8B, is displayed on the display device 309 of the computer C (step S23).

With the user registration screen displayed, when the “CANCEL” button is clicked using the input device 310 of the computer C (step S24), the center apparatus A terminates the user registration procedure, and the front page such as shown in FIG. 8A is displayed on the display device 309 of the computer C (step S21). On the other hand, when the “NEXT” button is clicked using the input device 310 of the computer C (step S24), it is determined whether all necessary data have been entered in the text boxes (step S25).

When all necessary data have not been entered (step S25), the center apparatus A presents a confirmation screen carrying a message indicating that all necessary data have not been entered, a message requesting for reentry, and a button “NEXT”, such as shown in FIG. 8C, for display on the display device 309 of the computer C (step S26). With this confirmation screen displayed, when the “NEXT” button is clicked using the input device 310 of the computer C (step S27), the user registration screen such as shown in FIG. 8B is displayed on the display device 309 of the computer C (step S23), and the above-described steps (steps S24 and S25) are repeated.

On the other hand, when all necessary data have been entered (step S25), the center apparatus A temporarily stores the entered data (step S28), and presents a confirmation screen carrying a message warning the user that the obtained information may be provided to communication providers and manufacturers, a message requesting user confirmation as to whether the registration should be effected or not, and buttons “OK”, “BACK”, and “CANCEL”, such as shown in FIG. 8D, for display on the display device 309 of the computer C (step S29). The information obtained here is used to urge communication providers to reexamine their communication costs or to develop new products.

With the confirmation screen displayed, when the “CANCEL” button is clicked using the input device 310 of the computer C (step S30), the center apparatus A terminates the user registration procedure, and the front page such as shown in FIG. 8A is displayed on the display device 309 of the computer C (step S21); when the “BACK” button is clicked using the input device 310 of the computer C (step S30), the user registration screen such as shown in FIG. 8B is displayed on the display device 309 of the computer C (step S23), and the earlier described steps (steps S24 and S25) are repeated. On the other hand, when the “OK” button is clicked using the input device 310 of the computer C (step S30), a download screen consisting of “LCR TABLE” as a button, such as shown in FIG. 8E, is displayed on the display device 309 of the computer C (step S31).

With the download screen displayed, when the “LCR TABLE” button is clicked using the input device 310 of the computer C (step S32), the center apparatus A, based on the temporarily stored data, reads out an LCR table optimum for the requesting communication apparatus from the LCR data management file 107 or prepares an optimum LCR table by processing the readout LCR table, and downloads to the computer C a file consisting of the thus readout or prepared LCR table with management data such as the version number of the LCR table, the telephone number of the center, update time, valid time, etc. included therein, and a program for transferring the LCR table to the communication apparatus B (step S33). The computer C stores the downloaded LCR table and program in the LCR data management file 306 and control data management file 308, respectively.

Then, the center apparatus A determines whether the downloading of the LCR table file is completed or not and whether the download has been terminated normally (step S34). If the downloading of the LCR table file has not been terminated normally, the download screen shown in FIG. 8E, plus a message notifying the user of the failure to terminate the download normally, is displayed on the display device 309 of the computer C (step S31), and the above-described steps (steps S32 to S34) are repeated. On the other hand, when the downloading of the LCR table file has been terminated normally, a confirmation screen carrying a message indicating the normal termination of the download and a button “NEXT”, such as shown in FIG. 8F, is displayed on the display device 309 of the computer C (step S35).

With the confirmation screen displayed, when the “NEXT” button is clicked using the input device 310 of the computer C (step S36), the center apparatus A effects data registration by storing the temporarily stored data into the user data management file 106 in the center apparatus A (step S37), and presents a registration completed screen carrying a message indicating the completion of the registration, the registration ID, and a button “NEXT, such as shown in FIG. 8G, for display on the display device 309 of the computer C (step S38). With this registration completed screen displayed, when the “NEXT” button is clicked using the input device 310 of the computer C (step S39), the center apparatus A terminates the user registration procedure and presents the front page, such as shown in FIG. 8A, for display on the display device 310 of the computer C (step S21).

In this way, according to the above control procedure, the user registration can be performed and the LCR table optimum for the user registered communication apparatus B can be downloaded to the computer C by using the large-scale network E.

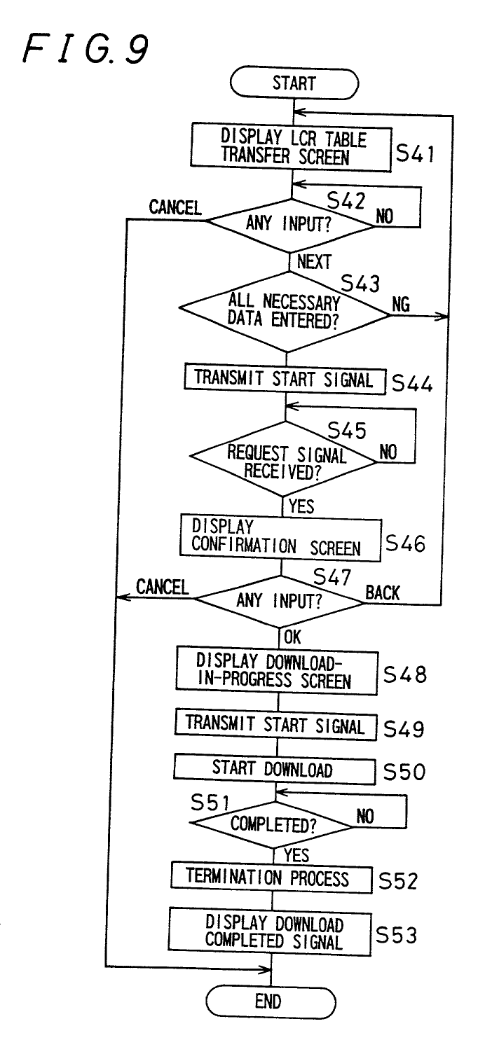

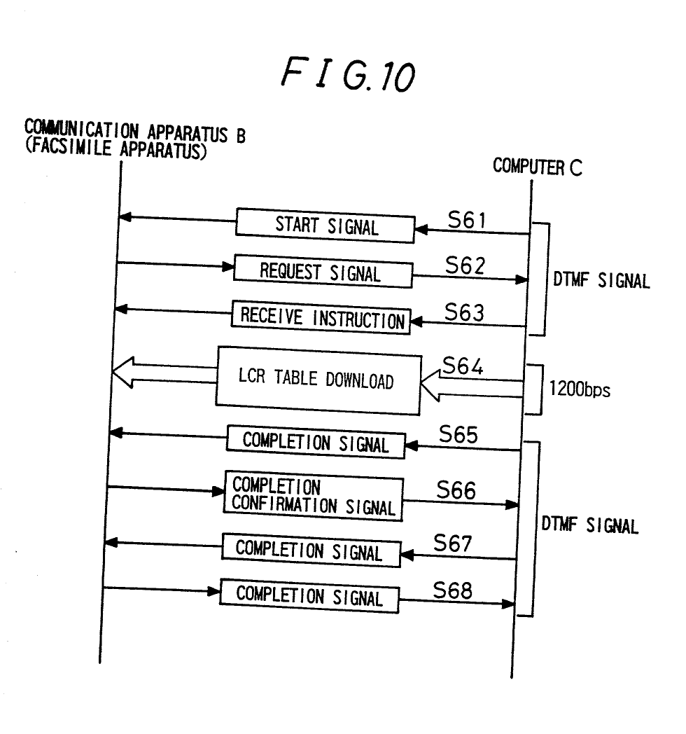

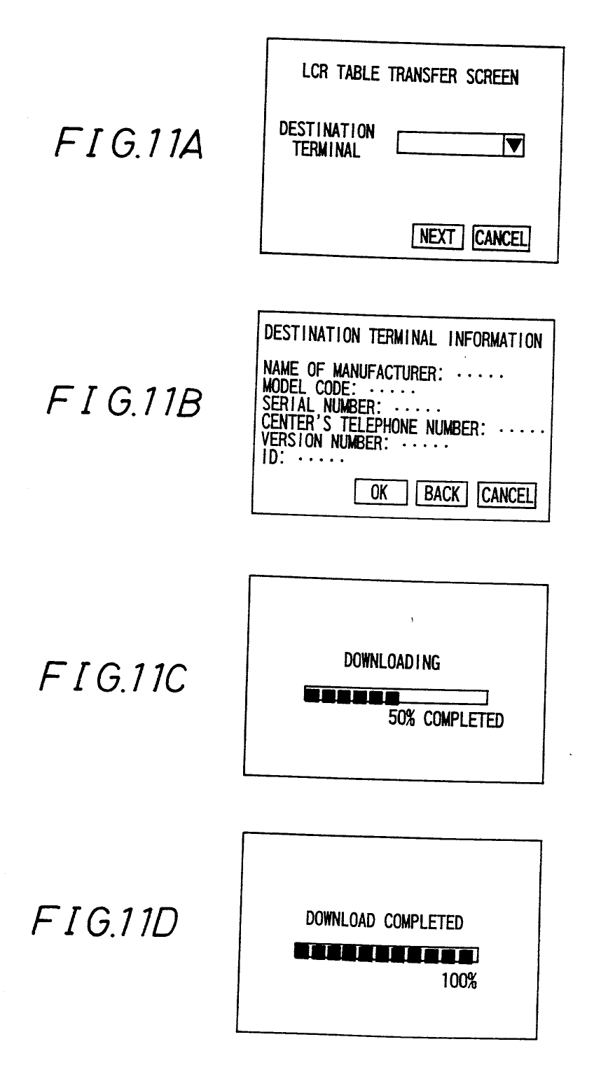

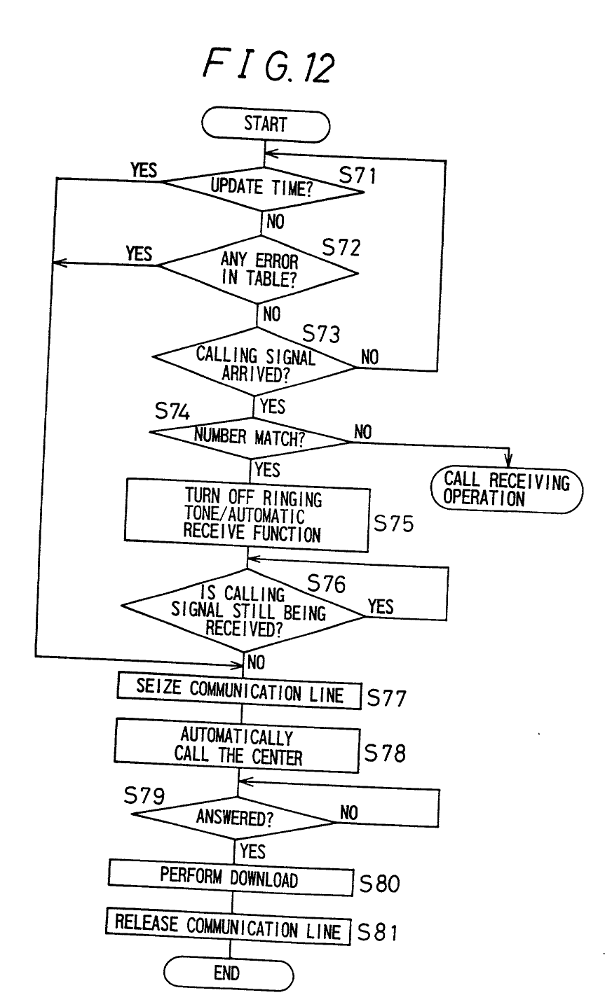

Next, referring to FIGS. 9, 10, and 11A to 11D, a description will be given of how the LCR table downloaded to the computer C at the time of the above user registration is transferred to the communication apparatus B via the small-scale network F. FIG. 9 is a flow chart illustrating the control procedure executed when transferring the LCR table, downloaded to the computer C at the time of the user registration, to the communication apparatus B via the small-scale network F such as a LAN, FIG. 10 is a sequence diagram illustrating the control procedure for the LCR table transfer of FIG. 9, and FIGS. 11A to 11D are explanatory diagrams showing display examples of LCR table transfer screens displayed on the display device 309 of the computer C during the LCR table transfer procedure of FIG. 9.

When the user, by using the input device 310, starts the program downloaded from the center apparatus A and stored in the control data management file 308, the LCR table transfer procedure is initiated, and an LCR table transfer screen consisting of a character string indicating the destination terminal, a text box for entering the destination terminal, and buttons “NEXT” and “CANCEL”, such as shown in FIG. 11A, is displayed on the display device 309 of the computer C (step S41).

With this LCR table transfer screen displayed, when the “CANCEL” button is clicked using the input device 310 of the computer C (step S42), the LCR table transfer procedure is terminated; on the other hand, when the “NEXT” button is clicked using the input device 310 of the computer C (step S42), it is determined whether data has been entered in the text box (step S43).

When necessary data has not been entered (step S43), the LCR table transfer screen shown in FIG. 11A, plus a message indicating that necessary data has not been entered, is displayed on the display device 309 of the computer C (step S41), and the above-described steps (steps S42 and S43) are repeated. On the other hand, when necessary data has been entered (step S43), a start signal indicating the start of the LCR table downloading is sent by using a DTMF signal to the destination terminal (communication apparatus B) via the interface 302 and the small-scale network F (steps S44 and S61). The communication apparatus B that received the start signal reads out the manufacturer name, model code, and serial number of the apparatus, the telephone number of the center, the current version number of the LCR table, the ID number, etc. from the control data management file 207, and transmits these pieces of information using DTMF signals to the computer C as a request signal responding to the start signal (step S62).

At the computer C that received the request signal, a confirmation screen, such as shown in FIG. 11B, consisting of character strings indicating the manufacturer name, model code, serial number, center's telephone number, version number, and ID number, the data retrieved for the respective items, and buttons “OK”, “BACK”, and “CANCEL”, is displayed on the display device 309 based on the data contained in the request signal (steps S45 and S46).

With this confirmation screen displayed, when the “CANCEL” button is clicked using the input device 310 (step S47), the LCR table transfer procedure is terminated; when the “BACK” button is clicked using the input device 310 (step S47), the LCR table transfer screen such as shown in FIG. 11A is displayed on the display device 309 (step S41), and the above-described steps (steps S42 to S47) are repeated. On the other hand, when the “OK” button is clicked using the input device 310 (step S47), a download-in-progress screen indicating the download is in progress, such as shown in FIG. 11C, is displayed on the display device 309 (step S48).

With this download-in-progress screen displayed, the computer C sends a receive instruction to the communication apparatus B by using a DTMF signal (step S49 and S63) and, based on the data contained in the request signal, reads out the LCR table from the LCR data management file 107 and transfers the thus readout LCR table to the communication apparatus B in the form of signals at 1200 bps conforming to ITU-T recommendation V.23 (steps S50 and S64). On the other hand, the communication apparatus B that received the receive instruction switches its operation to the data modem 204 ready to receive the LCR table, and stores the LCR table, transmitted and received from the center apparatus A, in the LCR data management file 208 and the management data, contained in the LCR table, in the control data management file 207.

After that, when the downloading of the LCR table is completed (step S51), the computer C sends a completion signal to the communication apparatus B by using a DTMF signal (step S65). The communication apparatus B that received the completion signal returns a completion confirmation signal to the computer C by using a DTMF signal (step S66), and the computer C that received the completion confirmation signal sends a clear signal to the communication apparatus B by using a DTMF signal (step S67). The communication apparatus B that received the clear signal sends a clear signal to the computer C by using a DTMF signal (step S68). While performing this series of termination operations (step S52), a download completed screen indicating the completion of the download, such as shown in FIG. 11D, is displayed on the display apparatus 309 (step S53), thus completing the LCR table transfer procedure.

Thus, according to the above control procedure, the LCR table downloaded at the time of the user registration initiated by an access from the computer C can be downloaded to the user registered communication apparatus B.

In the above control procedure, the LCR table optimum for the communication apparatus B is downloaded to the computer C via the large-scale network E when the computer C accesses for user registration, and the downloaded LCR table is downloaded to the communication apparatus B via the small-scale network F; alternatively, provisions may be made to download the LCR table optimum for the communication apparatus C directly to the communication apparatus C via the communication line D after the user registration has been made using the computer C.

More specifically, suppose, for example, the case where the communication apparatus B and the computer C are not interconnected via the small-scale network F, and where the computer C accesses for user registration and the LCR table is downloaded to the communication apparatus B; in this case, the center apparatus A temporarily stores the information obtained from the computer C and the individually set user ID in the user management file 106 (steps S21 to S28 in FIG. 7), and transmits the center's telephone number, together with a message instructing the user to make a call to the center's telephone number from the communication apparatus B to which the user desires to have the LCR table downloaded, and to enter the user ID, to the computer C for display on the display apparatus 309, and control is carried out so that when an access is made to the center's telephone number, and the user ID is entered, the remainder of the control procedure (from step S4 to step S11 in FIG. 5) is initiated by transmitting the start signal, based on the information corresponding to the user ID.

Next, a procedure for updating the LCR table using the communication line D will be described with reference to FIG. 12 in conjunction with FIG. 5. FIG. 12 is a flow chart illustrating the control procedure executed at the time of LCR table updating using the communication line D in FIG. 1.

When in a standby state, the communication apparatus B constantly compares the current time and date provided by the timer function with the update time and date of the LCR table (step S71), and monitors for any error in the LCR table stored in the LCR data management file 207 (step S72) and for the arrival of a calling signal from the communication line D (step S73). When a calling signal arrives from the communication line D, the control apparatus D determines whether the calling party information contained in the calling signal matches the center's telephone number stored in the control data management file 308 (step S74); when they do not match, the usual call receiving operation is executed, but when they match, a special call responding operation is executed by disabling the ringing tone, the automatic receiving function, etc. (step S75), and the communication line D is monitored for the arrival of a calling signal (step S76).

When the calling signal from the communication line D has ceased (step S76), or when the present time and date is past the update time and date (step S71), or when an error is detected in the LCR table (step S72), the communication line D is seized by controlling the interface 201 (step S77), and an automatic call is made to the center apparatus A by using the center's telephone number stored in the control data management file 308 (step S78).

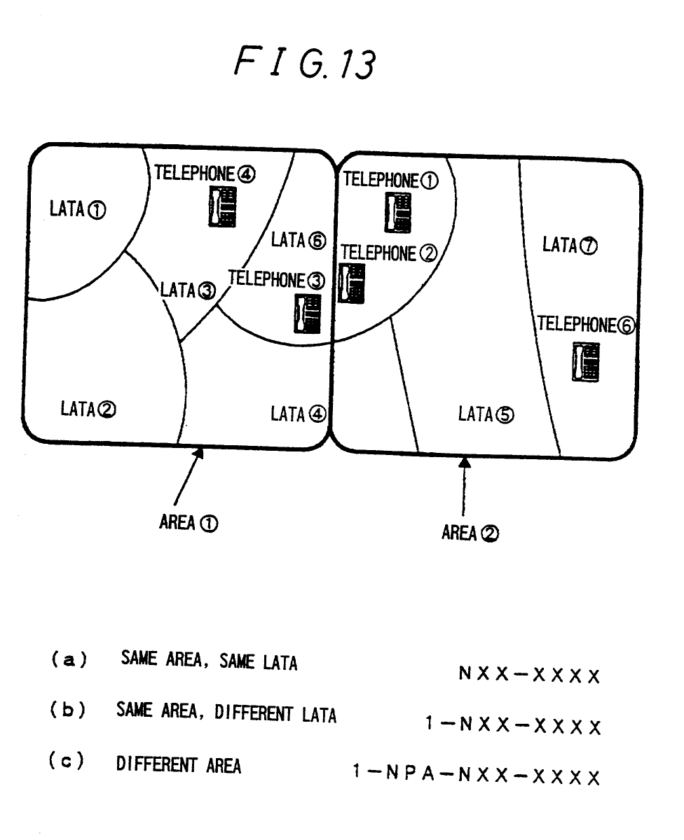

Referring to FIG. 13, the automatic calling function will be described by dealing with an example in which this communication system is deployed in the United States. FIG. 13 is an explanatory diagram illustrating a telephone numbering scheme used in the United States. As shown in FIG. 13, each telephone number consists of an area code (NPA), a LATA number (NXX), and a subscriber number (XXXX), and the same LATA number may cover two different areas, such as LATA (6) and LATA (4). When dialing from telephone (1), telephone (2) is in the same area and same LATA, telephone (3) is in the same LATA but in a different area, and telephone (6) is in the same area but in a different LATA. Telephone numbers to be dialed are (a) NXX-XXXX for the same area and same LATA, (b) 1-NXX-XXXX for a different LATA in the same area, and (c) 1-NPA-NXX-XXXX for a different area, and when this rule is not strictly adhered to, an access cannot be made. Accordingly, the area code, the LATA number, and the subscriber number are separately stored for the center's telephone number, and when making an automatic call for the first time, telephone numbers are dialed in the order of (c), (b), and (a), and the telephone number with which an access has been successfully made to the center apparatus A is stored as the center's telephone number which is thereafter used when making an automatic call.

When the center apparatus A answers (step S79), the latest LCR table optimum for the communication apparatus B is downloaded (step S80) in accordance with the prescribed procedure (steps S4 to S11), and when the downloading is completed, the communication line D is released (step S81), thus terminating the LCR table update procedure, and the communication apparatus B is placed in the standby state. When the version of the LCR table already stored in the communication apparatus B is the same as the version of the latest LCR table, the download is not carried out to save the communication cost.

Thus, according to the above control procedure, when the update time contained in the LCR table arrives, or when any error is detected in the LCR table, or when there is a request from the center, the latest LCR table can be downloaded to the communication apparatus B by automatically accessing the center apparatus A.

The center apparatus A may access the communication apparatus B not only when it becomes necessary to update the LCR table, but also when the center's telephone number is changed because the center is moving; in the latter case, provisions should be made to update only the center's telephone number but not update the LCR table itself, and also to include therein the time at which the new center's telephone number becomes valid, and control should be carried out so that the current center's telephone number is used before the specified time and, thereafter, the new center's telephone number.

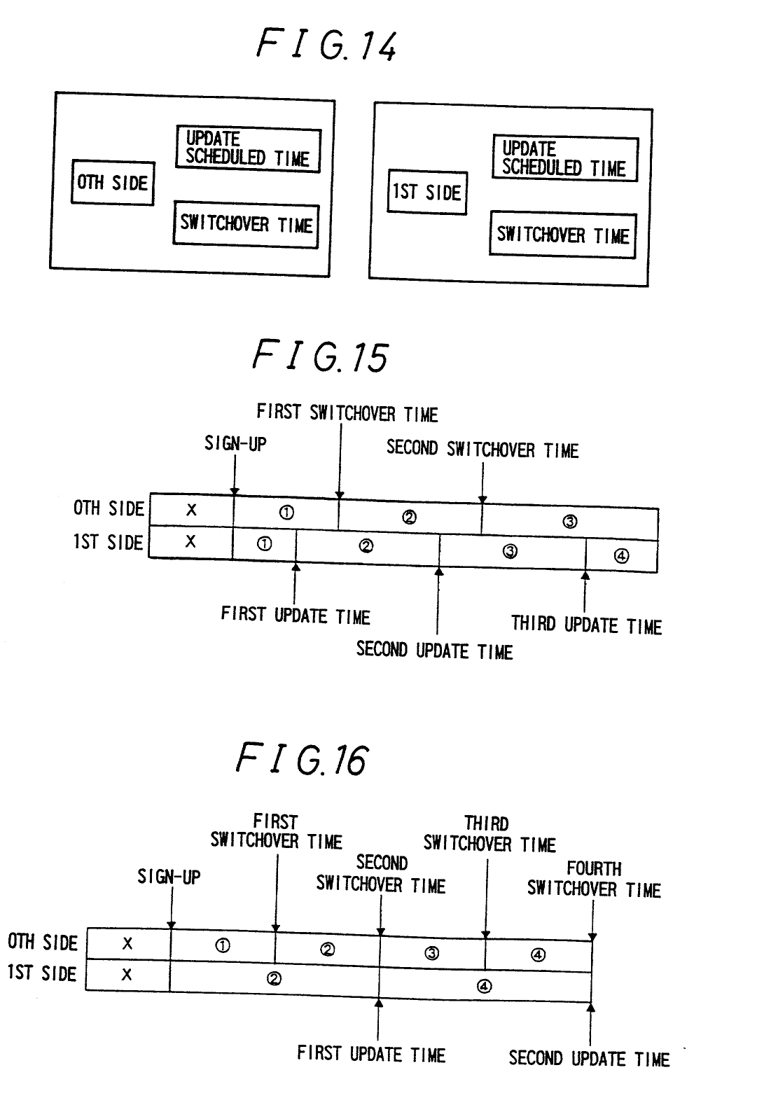

FIG. 14 is a diagram showing one example of an LCR table format, and FIG. 15 is a diagram showing one example of LCR table update timing. Consider, for example, the case where the communication apparatus B is provided with two areas for storing LCR tables, one denoted as 0th side and the other as 1st side, each capable of storing update scheduled time and switchover time, as shown in FIG. 14. Then, as shown in FIG. 15, at the time of user registration, LCR table (1) which is immediately available for use is stored on both the 0th and 1st sides; when the first update time arrives, LCR table (2) which becomes available for use from the first switchover time is stored on the 1st side; when the first switchover time arrives, the LCR table (2) on the 1st side is copied to the 0th side; when the second update time arrives, LCR table (3) which becomes available for use from the second switchover time is stored on the 1st side; when the second switchover time arrives, the LCR table (3) on the 1st side is copied to the 0th side; when the third update time arrives, LCR table (4) which becomes available for use from the third switchover time is stored on the 1st side; and so on. In this way, every time a call is initiated, the lowest cost route is chosen always based on the LCR table stored on the 0th side. Alternatively, the switchover time and update time may be controlled as shown in FIG. 16; by performing control as illustrated, more than one LCR function can be maintained with a single download operation.

The above control procedure has been described dealing with the case where updating of the LCR table is carried out using the communication line D, but the invention is not limited to this particular example. Alternatively, the updating may be carried out by the computer C using the large-scale network E; in this case, an ID is assigned to each user at the time of user registration and, thereafter, when the user ID is entered, whether the LCR table needs updating or not is displayed on the display device 309 of the computer C so that the LCR table can be downloaded. Furthermore, E-mail may be used when the center notifies the user that the LCR table needs updating.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A communication system comprising:
a center apparatus in which a least cost routing table containing communication cost information for each communication line is stored; and
a communication apparatus for selecting a communication line to be used based on the least cost routing table,
wherein when the communication apparatus accesses the center apparatus, the LEAST COST ROUTING table is downloaded to the communication apparatus.

2. The communication system of claim 1, wherein the center apparatus selects or prepares the least cost routing table based on calling party information that is reported when an access occurs from the communication apparatus thereto, and the thus selected or prepared least cost routing table is downloaded from the center apparatus to the communication apparatus.

3. A communication system comprising:
a center apparatus in which a least cost routing table containing communication cost information for each communication line is stored;
a computer to which the least cost routing table is downloaded from the center apparatus; and
a communication apparatus for selecting a communication line to be used based on the least cost routing table transferred from the computer,
wherein when the computer accesses the center apparatus, the center apparatus downloads the least cost routing table to the computer.

4. The communication system of claim 2, wherein the center apparatus selects or prepares the least cost routing table based on information unique to the communication apparatus which information is transmitted from the communication apparatus or the computer, and the thus selected or prepared least cost routing table is downloaded from the center apparatus to the communication apparatus or the computer.

5. The communication system of any one of claims 1 to 4, wherein data concerning users using the center apparatus is provided to a telephone communication carrier through a network.

6. A communication apparatus comprising:
control means for accessing a center apparatus where a least cost routing table containing communication cost information for each communication line is stored, downloading the least cost routing table to be downloaded from the center apparatus, and selecting a communication line to be used based on the downloaded least cost routing table.

7. A communication apparatus comprising:
control means for accessing a center apparatus, allowing a least cost routing table containing communication cost information for each communication line stored in the center apparatus, to be downloaded from the center apparatus to a computer, receiving the least cost routing table through the computer to which the least cost routing table has been downloaded, and selecting a communication line to be used based on the thus received least cost routing table.

8. The communication apparatus of claim 6 or 7, wherein the control means determines timing of making an access to the center apparatus based on time and date data included in the least cost routing table, and the center apparatus is accessed with the thus determined timing to download the least cost routing table from the center apparatus.

9. The communication apparatus of claim 6 or 7, wherein when contents of the least cost routing table are lost, the control means detects the contents having been lost, and accesses the center apparatus to download the least cost routing table from the center apparatus.

10. A center apparatus comprising:
least cost routing data management means for maintaining a least cost routing table containing communication cost information for each communication line; and
control means for, in response to an access of a communication apparatus or computer to the center apparatus, allowing the least cost routing table to be downloaded from the least cost routing data management means to the communication apparatus or computer while keeping a line connected.

11. The center apparatus of claim 10, wherein the control means selects or prepares a least cost routing table based on calling party information that is reported when the center apparatus is accessed by the communication apparatus, and downloads the thus selected or prepared least cost routing table to the communication apparatus.

12. The center apparatus of claim 10, wherein the control means selects or prepares the least cost routing table based on information unique to the communication apparatus transmitted from the communication apparatus or the computer, and downloads the thus selected or prepared least cost routing table to the communication apparatus or the computer.

13. A method for downloading a least cost routing table comprising:
a step of, when a communication apparatus or computer accesses a center apparatus in which a least cost routing table containing communication cost information for each communication line is stored, downloading the least cost routing table to the communication apparatus or computer while keeping a communication line connected.

14. A communication system comprising:
a center apparatus in which a least cost routing table containing communication cost information for each communication line is stored; and
a communication apparatus for selecting a communication line to be used based on the least cost routing table downloaded from the center apparatus to the communication apparatus,
wherein when the communication apparatus accesses the center apparatus, the least cost routing table to which a center telephone number is appended is downloaded from the center apparatus to the communication apparatus, and in subsequent accesses of the communication apparatus to the center apparatus the communication apparatus uses the center telephone number appended to the least cost routing table.

15. A communication apparatus comprising:
control means to which a least cost routing table containing communication cost information for each communication line stored in a center apparatus is downloaded in response to an access to the center apparatus, for selecting a communication line to be used based on the thus received least cost routing table,
wherein in subsequent accesses of the control means to the center apparatus the control means uses the center telephone number appended to the least cost routing table.

16. The communication apparatus of any one of claims 6, 7 and 15, wherein the control means compares a pre-registered center telephone number with calling party information reported when an access is received, and when the access is judged as being from the center apparatus, upon termination of the access request the control means accesses the center apparatus and the least cost routing table is downloaded to the control means from the center apparatus.

17. The communication apparatus of claim 16, wherein as a result of the comparison between the pre-registered center telephone number and the calling party information reported when an access is received, when the access is judged as being from the center apparatus, the control means does not execute a call arrival alerting operation or a call receiving operation.

18. The communication apparatus of claim 15, wherein when the center telephone number and valid time information is appended to the least cost routing table, before the valid time the control means accesses the center apparatus by using the existing center telephone number, and after the valid time is reached, the control means accesses the center apparatus by using the center telephone number appended to the least cost routing table.

19. A method for downloading comprising:
a step of, when a communication apparatus accesses a center apparatus where a least cost routing table containing communication cost information for each communication line is stored, downloading the least cost routing table with a center telephone number appended thereto, to the communication apparatus.

20. A communication system comprising:
a center apparatus in which a least cost routing table containing communication cost information for each communication line is stored; and
a communication apparatus for selecting a communication line to be used based on the least cost routing table,
wherein the center apparatus downloads to the communication apparatus a plurality of least cost routing tables with valid time information appended thereto, and wherein based on the valid time information appended to the plurality of downloaded least cost routing tables, the communication apparatus selects a least cost routing table to be used for the line selection from among the plurality of downloaded least cost routing tables.

21. A communication system comprising:
a center apparatus in which a least cost routing table containing communication cost information for each communication line is stored; and
a communication apparatus for selecting a communication line to be used based on the least cost routing table,
wherein the least cost routing table containing information about a new communication line scheduled to be implemented is downloaded from the center apparatus to the communication apparatus, and wherein the communication apparatus determines whether the new communication line is available for service, and performs a line selection to be used based on the downloaded least cost routing table from which the new communication line information is excluded when the new communication line is not yet available for service, or in which table the new communication line information is kept when the new communication line is available for service.

22. A communication system comprising:
a center apparatus in which a least cost routing table containing communication cost information for each communication line is stored; and
a communication apparatus for selecting a communication line to be used based on the least cost routing table,
wherein from the center apparatus to the communication apparatus is downloaded the least cost routing table with information indicating that the least cost routing table is for a demonstration purpose appended thereto, and wherein the communication apparatus is able to change the demonstration indicating information and, as long as the demonstration indicating information is appended to the least cost routing table, the communication apparatus does not execute a line selection based on the least cost routing table but displays a communication cost for an actually used communication line along with a communication cost for a communication line that would be selected if the demonstration least cost routing table were used, and after the demonstration indicating information is changed, the communication apparatus performs a line selection based on the least cost routing table whose appended information has been changed.

23. The communication system of any one of claims 20 to 22, wherein when the center apparatus is accessed by the communication apparatus, the least cost routing table is downloaded from the center apparatus to the communication apparatus while keeping the communication line connected.

24. A communication apparatus comprising:
control means for accessing a center apparatus where a least cost routing table containing communication cost information for each communication line is stored, downloading from the center apparatus a plurality of least cost routing tables with valid time information appended thereto to be downloaded, and selecting a communication line to be used based on the downloaded least cost routing tables,
wherein the control means selects the least cost routing table to be used for the line selection, based on the valid time information appended to the least cost routing tables.

25. A communication apparatus comprising:
control means for accessing a center apparatus where a least cost routing table containing communication cost information for each communication line is stored, downloading from the center apparatus a least cost routing table containing information about a new communication line scheduled to be implemented, and selecting a communication line to be used based on the downloaded least cost routing table,
wherein the control means determines whether a new communication line is available for service, and performs a line selection based on the least cost routing table from which the new communication line information is excluded when the new communication line is not yet available for service, or from which the new communication line information is not excluded when the new communication line is available for service.

26. A communication apparatus comprising:
control means for, when the communication apparatus accesses a center apparatus where a least cost routing table containing communication cost information for each communication line is stored, downloading from the center apparatus the least cost routing table with information indicating that the least cost routing table is for a demonstration purpose, appended thereto, the control means being capable of changing demonstration-indicating information,
wherein as long as the demonstration-indicating information is appended to the least cost routing table, the control means does not execute a line selection based on the least cost routing table but displays a communication cost for an actually used communication line along with a communication cost for a communication line that would be selected if the demonstration least cost routing table were used, and when the demonstration-indicating information is changed, the control means carry out a line selection based on the least cost routing table whose appended information has been changed.

27. A method for downloading a least cost routing table:
a step of, when a communication apparatus accesses a center apparatus where a plurality of least cost routing tables containing communication cost information for each communication line are stored, downloading the plurality of least cost routing tables along with valid time data appended thereto, to the communication apparatus,
wherein the communication apparatus selects a least cost routing table to be used for line selection from among the plurality of downloaded least cost routing tables based on the valid time data appended thereto.

28. A method for downloading a least cost routing table comprising:
a step of, when a communication apparatus accesses a center apparatus where a least cost routing table containing communication cost information for each communication line is stored, downloading the least cost routing table including information about a new communication line scheduled to be implemented, to the communication apparatus,
wherein when the new communication line is not yet available for service, the communication apparatus executes a line selection to be used based on the downloaded least cost routing table from which the information about the new communication line is excluded, and when the new communication line is available for service, the communication apparatus executes a line selection to be used based on the downloaded least cost routing table in which the information about the new communication line is included.

29. A method for downloading a least cost routing table comprising:
a step of, when a communication apparatus accesses a center apparatus where a least cost routing table containing communication cost information for each communication line is stored, downloading from the center apparatus to the communication apparatus a least cost routing table with information indicating that the least cost routing table is for a demonstration purpose, appended thereto,
wherein the communication apparatus is able to change the demonstration indicating information, and as long as the demonstration indicating information is appended to the least cost routing table, the communication apparatus does not execute a line selection based on the least cost routing table but displays a communication cost for an actually used communication line along with a communication cost for a communication line that would be selected when the demonstration least cost routing table were used, and after the demonstration indicating information is changed, the communication apparatus performs a line selection based on the least cost routing table whose appended information has been changed.
